(19) United States
(12) Patent Application Publication
(10) Pub. No.: US 2008/0196989 A1
(43) Pub. Date: Aug. 21, 2008

(54) Drive Train of a Motor Vehicle and Method For Controlling an Automated Engine Clutch

(75) Inventors: Rainer Petzold, Friedrichshafen (DE); Mario Steinborn, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/914,008

(22) PCT Filed: Apr. 20, 2006
(86) PCT No.: PCT/EP06/03635

§ 371 Date: Nov. 9, 2007

(30) Foreign Application Priority Data
May 10, 2005 (DE) 10 2005 021 417.7

(51) Int. Cl. F16D 48/04

(52) U.S. Cl. 192/31; 701/67

(57) ABSTRACT

A drive train of a motor vehicle including an internal combustion engine, a transmission which is connected to an axle drive and has a variable transmission ratio, and an automatic engine clutch located in the flow of power between the engine and transmission, is designed as an actively engagable friction clutch and transmits torque which can be controlled by a pressure medium. To improve control and a faster response the engine clutch does not include a pressing spring but has a pressing apparatus actuated by a pressure medium. The pressing apparatus is connected to a pressure medium source such that the engine clutch is engaged when in a non-actuated state by applying maximum pressure to the pressing apparatus and is disengaged, at least partially, in an actuated state, to lower clutch torque transmission or for disengaging the engine clutch by applying a reduced active pressure to the pressing apparatus.

This application is a National Stage completion of PCT/EP2006/003634 filed Apr. 20, 2006, which claims priority from German patent application serial no. 10 2005 021 417.7 filed May 10, 2005.

### FIELD OF THE INVENTION

The present invention relates to a drive train of a motor vehicle comprising a drive engine configured as an internal combustion engine, a transmission which is connected to an axle drive and has a variable transmission ratio, and further comprises an automatic engine clutch which is disposed in flow of power between the drive engine and the transmission and is configured as a friction clutch that can be actively engaged, and the transmittable torque (clutch torque) of which can be set so that it may be controlled by a pressure medium.

The present invention further relates to a method for controlling an automatic engine clutch disposed in the drive train of a motor vehicle in the flow of power between a drive engine, configured as an internal combustion engine, and a transmission which is connected to an axle drive and has a variable transmission ratio, the clutch being configured as a friction clutch that can be actively engaged and the transmittable torque (clutch torque) of which can be set so that it may be controlled by a pressure medium.

### BACKGROUND OF THE INVENTION

Prior art engine clutches are known as friction clutches that can be engaged passively and/or actively. In the inactive idle state, a passively engageable friction clutch is engaged, i.e. by an external operating force applied by the driver or generated by an actuator, mostly by an automatically acting, typically spring-supported pressing apparatus, and disengaged at least partially in the actuated state by applying a controllable operating force to a disengaging device that is actively connected to the pressing apparatus. In the inactive idle state, an actively engageable friction clutch is completely disengaged, i.e. by an external operating force, and at least partially engaged in the active state by applying a controllable operating force to an associated pressing apparatus.

An automatically controllable engine clutch that can be passively engaged by means of a hydraulic actuator is described, for example, in DE 43 09 901 A1. The engine clutch in question is a known single-disk dry clutch, whose pressing apparatus comprises a diaphragm spring disposed between the clutch cover attached to the flywheel of the drive engine and the clutch pressure plate on the transmission side. The associated hydraulic actuator is formed by a hydraulic slave cylinder that is connected, via a hydraulic line, to a hydraulic master cylinder. The master cylinder is part of an operating cylinder of a hydraulic control, which is controlled via a proportional solenoid valve or two clocked solenoid control valves.

The disengaging and thus the transmittable torque of the engine clutch is controlled via a path sensor provided on the operating cylinder. Hence, this is a relatively complex path control for an automatic friction clutch.

The advantage of this clutch design is that the engine clutch remains engaged or automatically switches over to the engaged state in case of failure, which is mostly related to pressure loss in the hydraulic control. This will allow the driver to drive the vehicle to a safe parking area or to a repair shop if the failure occurs while driving.

The disadvantage of this clutch design, however, is the large number of required components, particularly for the pressing apparatus and disengaging device, as well as the complexity of the clutch control, which is especially required because of the non-proportional characteristic curve of the diaphragm spring. In addition, in order to set a specific clutch torque starting from the non-actuated state, free travel has to be first bypassed and subsequently the contact overpressure relieved by the actuator, which leads to considerable delay and overall poor clutch control response.

In contrast, a clutch that can be controlled automatically and engaged actively via a hydraulic actuator is known from DE 102 40 679 B4, which apart from being applicable as a power shift clutch or power shift brake in an automatic planetary gear transmission can also be used as an engine clutch. The clutch is a known multi-disk clutch (wet clutch) operating in an oil bath, whose pressing apparatus is formed by a hydraulic operating cylinder, whose piston can be placed unilaterally in contact with the first disk of the disk set and whose pressure zone is enclosed between the housing and piston.

By means of a special spring arrangement it is possible, on the one hand, to achieve that the piston in the non-actuated state is pressed into a position spaced from the first disk by a spring-supported reset force, so that all disks are without load and the disk clutch is completely disengaged. On the other hand, when the piston is actuated, a strong increase in the spring-supported reset force is brought about by the spring arrangement when the first disk is reached, i.e. at the beginning of torque transmission, which makes adequate control of the set clutch torque, in particular a simple and cost-effective implementation of a pressure control setting of the transmittable torque of the engine clutch, possible.

A serious disadvantage of this clutch design, however, is that the engine clutch is automatically disengaged when a failure, that is mostly associated with pressure loss in the hydraulic control caused by leakage, occurs. Therefore, if on a drive, the driver has no possibility of at least driving the involved motor vehicle to a safe parking area or to a repair shop; rather, the motor vehicle will remain at a place that cannot be determined by the driver and may be dangerous, having to be towed away. Likewise, a disadvantage of this design is that in order to set a specific clutch torque starting from the non-actuated state, free travel has to be first bypassed by the actuator, which leads to a certain delay of the clutch control response.

### SUMMARY OF THE INVENTION

With this as a background, it is the object of the present invention to propose an automatic engine clutch of a drive train of the type described at the beginning, which comprises improved controllability and rapid response by means of a simple and cost-effective design. In addition, a method for controlling such an engine clutch shall be indicated.

The object of the engine clutch is achieved in that the engine clutch does not comprise a pressure spring and includes a pressing apparatus actuated by a pressure medium, the apparatus being connected to a pressure medium source so that in the non-actuated state the engine clutch is engaged by applying maximum pressure to the pressing apparatus, and in the actuated state the engine clutch is at least partially disengaged by applying a reduced active pressure to the pressing apparatus for setting a lower clutch torque or disengaging the engine clutch.

The engine clutch according to the present invention, which can be a dry or wet clutch, in principle is an actively engageable friction clutch, whose transmissible torque increases proportionally with the active pressure in the pressing apparatus actuated by a pressure medium. As, provided adequate system pressure of the pressure medium source is available, the engine clutch is completely engaged in the non-actuated state, the control principle rather corresponds to that of a passively engageable friction clutch.

In the present description, when starting the motor vehicle after standing still for some time, the engine clutch is first automatically engaged by applying maximum pressure from the pressure medium source to the pressing apparatus. Thereupon, if necessary, a lower clutch torque can be set by a controlled reduction of the active pressure in the pressing apparatus, or the engine clutch can be disengaged completely by depressurizing of the pressing apparatus. As the clutch torque is proportional to the active pressure, improved controllability is achieved compared to known clutch designs, and a particularly simple and cost-effective implementation of the pressure control of the engine clutch is therefore possible.

The engine clutch setting and disengaging procedures are carried out in each case without free travel, which results in quicker clutch control response. Therefore, starting and maneuvering can be performed more dynamically and the shifting times of shifting operations can be reduced in a gearbox configured as a manual gearbox.

Likewise, compared to an engine clutch with a spring-supported pressing apparatus, the design of the clutch according to the present invention saves installation space and components. Based on the improved controllability of the engine clutch, in particular in relation to the (buildup and release) times of the active pressure in the pressing apparatus, the otherwise usual lining spring loading can be obviated with an engine clutch designed as a dry clutch.

The pressing apparatus preferably comprises an operating cylinder, an operating piston mounted axially displaceably in the operating cylinder and a pressure zone enclosed by the operating cylinder and operating piston, the zone being connected to the pressure medium source via a connecting line and a clutch control valve, the operating cylinder or operating piston being connected to a supporting element of the engine clutch and the respectively other component (operating piston or operating cylinder) to a pressing element of the engine clutch.

The pressing force of the pressing apparatus can be supported with respect to the engine housing of the drive engine or with respect to the transmission housing of the drive train. As this would require a complex rotatable mounting of a supporting component, the pressing force is conveniently supported inside the engine clutch, e.g. in a dry clutch by a clutch cover, which is attached to the flywheel of the drive engine on the engine side and carries the pressing apparatus on the transmission side connected actively to a pressure plate as a pressing element in the direction of the drive engine.

In an engine clutch configured as a dry clutch of this type, the operating cylinder preferably is a ring pan-shaped molding in the clutch cover and the correspondingly ring-shaped operating piston is connected to the pressure plate. In this way, a particularly simple and space-saving pressing apparatus is implemented obviating a complex engaging device.

The employed pressure medium source can be configured as a pressure supply device with a pressure reservoir fed by a pressure medium pump, preferably using a pressure supply device already available for other purposes. Thus, the pressing apparatus can be activated pneumatically and connected to an available compressed air supply device of the motor vehicle. Likewise, the pressing apparatus can be actuated hydraulically and connected to an available hydraulic pressure supply device of the motor vehicle and/or gearbox, e.g. for the supply of a hydraulic shifting or transmission ratio control device of the drive train.

The associated clutch control valve is conveniently configured so that a connection of the connecting line to the pressure medium source is completely open in the non-actuated state, and a connection of the connecting line to a depressurized line is completely closed, and that in the actuated state the connection of the connecting line to the pressure medium source is at least partially closed and the connection of the connecting line to the depressurized line is at least partially open. A corresponding clutch control valve is, for example, configured as a pressure control valve in the form of a 3/2-way solenoid valve with a connection of a connecting line to the pressure medium source, a connection of the connecting line to the pressure zone of the pressing apparatus and a connection to a depressurized line.

In a more advantageous variant, the clutch control valve is not a single 3/2-way valve, but two single 2/2-way valves. Of these, a first 2/2-way valve is connected, via a connecting line, to the pressure medium source as well as, via another connecting line, to the above mentioned pressure zone. In contrast, the second 2/2-way valve is connected to the pressure zone, via a connecting line and, via a further connection, to a depressurized line. Compared to the 3/2-way valve, a design of this type enables better controllability of the engine clutch.

The activation of both 2/2-way valves is based on information provided by a pressure sensor which detects the pressure in the pressure zone of the engine clutch and transmits it to a control device. This control device controls the transmission torque of the engine clutch by the expedient actuation of both 2/2-way valves.

In order to maintain the clutch control when there is a pressure loss in the pressure medium source, a self-closing check valve is advantageously disposed in the direction of the pressure medium source between the clutch control valve and the pressure medium source. A separate pressure reservoir disposed between the clutch control valve and the pressure medium source can also be provided for the same purpose. Thus, undesired disengagement of the engine clutch can be prevented, and if a failure occurs, driving can be continued at least temporarily until a safe parking area or repair shop can be reached.

As the system pressure of the pressure medium source can be subject to certain operative fluctuations or be controlled dependent on load, in order to simplify the clutch control, it is advantageous if a pressure limiting valve is disposed between the clutch control valve (for example a 3/2-way valve or two 2/2-way valves) and the pressure medium source so that the system pressure of the clutch control may be limited.

In order to prevent undesired creep torque and facilitate load-free shifting with a drive train configured as a manual gearbox, the engine clutch and/or pressing apparatus can conveniently be provided with a return spring for complete disengagement of the engine clutch if the pressing apparatus is depressurized.

The task involving the method for controlling the engine clutch is configured without a pressure spring and has a pressing apparatus that is actuated by a pressure medium and is connected to a pressure medium source so that the engine clutch is engaged in the non-actuated state by applying maximum pressure to the pressing apparatus, and is disengaged at least partially in the actuated state for setting a lower clutch torque or for disengaging the engine clutch by applying reduced active pressure to the pressing apparatus.

Concretely, in the case of a connection of the pressing apparatus to the pressure medium source via a connecting line and a clutch control valve, this preferably takes place, in that, in the non-actuated state a connection of the connecting line with the pressure medium source is completely open and a connection of the connecting line with a depressurized line is completely closed at the clutch control valve, and, in that, in the actuated state the connection of the connecting line with the pressure medium source is at least partially closed and the connection of the connecting line with the depressurized line is at least partially open at the clutch control valve. The setting of the clutch torque of the engine clutch, via the pressing apparatus, is preferably implemented as a pressure control element that is technically easy to implement.

For this procedure, a combination of a 3/2-way valve and two single 2/2-way valves can be used as clutch control valves for applying pressure to the pressure zone of the engine clutch. In addition, a pressure control valve mounted upstream of the clutch control valve is used, with which the maximum pressure for the pressure zone can be set.

Finally, a further development of the method according to the present invention provides that the current pressure in the pressure zone is detected by means of a pressure sensor and used for controlling the clutch control valve and/or both 2/2-way valves, more precisely, the transmission torque of the engine clutch.

### BRIEF DESCRIPTION OF THE DRAWINGS

A drawing of an exemplary embodiment is attached to the description for the purpose of exemplification of the present invention. The only drawing shows:

FIG. 1 as a schematic diagram of a drive train with an engine clutch according to the present invention and an associated control system.

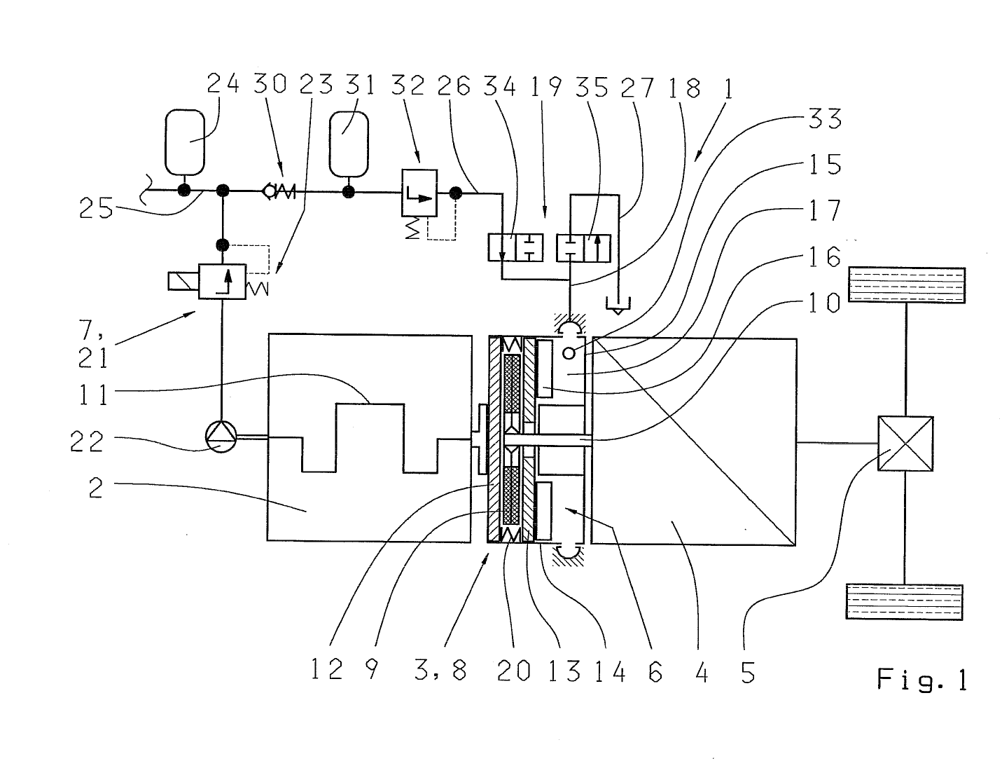

### DETAILED DESCRIPTION OF THE PREFERRED EMBODIMENTS

A drive train 1 of a motor vehicle comprises a drive engine 2 that is configured as an internal combustion engine, a drive train 4 with a variable, i.e. a stepwise shiftable or continuously adjustable, transmission ratio connected to an axle drive 5, and an automatic engine clutch 3 disposed in the power flow between the drive engine 2 and drive train 4, the clutch in the present example being configured as a friction clutch that can be actively engaged, and the transmittable torque (clutch torque) thereof being adjustably controlled by a pressure medium.

In general terms, the engine clutch 3 is configured without a pressing spring and has a pressing apparatus 6 that is actuated by a pressure medium and is connected to a pressure medium source 7 such that in the non-actuated state the engine clutch 3 is engaged by applying a maximum pressure to the pressing apparatus 6, and in the actuated state is disengaged at least partially for setting a lower clutch torque or for disengaging the engine clutch 3 by applying a reduced active pressure to the pressing apparatus 6.

In the present description, the engine clutch 3 is an exemplary single-disk dry clutch 8. Thus, a drive plate 9, which is mounted in the known way non-rotatably and axially displaceably on the input shaft 10 of the drive train 4, is disposed between a flywheel 12 firmly connected to the crankshaft 11 of the drive engine 2 and a pressure plate 13 on the transmission side.

The pressure plate 13 is mounted non-rotatably and axially displaceably in a clutch cover 14, which is firmly connected to the flywheel 12. The clutch cover 14 comprises an operating cylinder 15 formed by ring-shaped molding on the gearbox side, in which a likewise ring-shaped operating piston 16, that is connected to the pressure plate 13, is mounted axially displaceably.

The operating cylinder 15 and operating piston 16 encompass a ring-shaped pressure zone 17 and form the pressing apparatus 6 of the engine clutch 3. In this case, the pressure zone 17 is connected to the pressure medium source 7 via a connecting line 18 and a clutch control valve 19.

By building up active pressure in the pressure zone 17, the pressure plate 13, acting as a pressing apparatus, is pressed by the operating piston 16 in the direction of the drive engine 2, and the driver disk 9 is clamped between the flywheel 12 and pressure plate 13, whereupon a torque is transmitted from the crankshaft 11 of the drive engine 2 to the input shaft 10 of the drive train 4. In the process, the clutch cover 14 acts, via the operating cylinder 15, as a supporting element to support the pressing force generated by means of the pressing apparatus 6.

The engine clutch 3 is disengaged in the depressurized state of the pressure zone 17, which in the present description is ensured by putting a return spring 20 between the flywheel 12 and pressure plate 13 so as to overcome frictional resistance.

In the illustrated exemplary embodiment, the pressing apparatus 6 is actuated pneumatically. Hence, a compressed air supply device 21 of the motor vehicle is used as a pressure medium source 7. This device comprises a compressor 22 driven by the drive engine, by means of which compressed air can be conveyed, via a controllable pressure limiting valve 23, to a system pressure line 25 provided with a pressure reservoir 24. Loads, which are not illustrated, are connected to the system pressure line 25.

The clutch control valve 19 is a pressure control valve with a connection, via a connecting line 26, to the pressure medium source 7, a connection, via of the connecting line 18 to the pressure zone 17 of the pressing apparatus 6 and a connection to a depressurized line 27.

In the exemplary embodiment illustrated in the only figure, the clutch control valve 19 is implemented by two single 2/2-way valves. Of these, a first 2/2-way valve 34 is connected, via a connecting line 26, to the pressure medium source 7 and, via a further connecting line 18, to the pressure zone 17. In contrast, the second 2/2-way valve 35 is connected to the pressure zone 17 via the connecting line 18 and, via a further connection, to the depressurized line 27.

In order to control both 2/2-way valves 34, 35, a pressure sensor 33 is preferably provided, which can detect the pressure in the pressure zone 17 of the engine clutch 3, 8 and transmit it to a control device. This control device controls the transmission torque of the engine clutch by expedient actuation of both 2/2-way valves 34, 35.

By setting intermediate positions at the clutch control valve 19 and/or both 2/2-way valves 34 and 35, the active pressure in the pressure zone 17 of the pressing apparatus 6 and consequently the transmittable torque of the engine clutch 3 is infinitely variable.

In order to maintain the clutch control when there is a pressure loss in the pressure medium source 7, a check valve 30 closing the direction of the pressure medium source 7 and a separate pressure reservoir 31 are disposed in the connecting line 26. Furthermore, the connecting line 26 is provided with a controllable pressure limiting valve 32, for example a proportional valve, for limiting the system pressure of the clutch control.

As a result of the relatively low component stress, substantially no-play configuration and possible pressure control, the engine clutch 3 according to the present invention presents improved controllability and quicker response with a simple and cost-effective design.

### REFERENCE NUMERALS

1 Drive train
2 Drive engine
3 Engine clutch
4 Transmission
5 Axle drive
6 Pressing apparatus
7 Pressure medium source
8 Single-disk dry clutch
9 Drive plate
10 Input shaft
11 Crankshaft
12 Flywheel
13 Pressure plate, pressing element
14 Clutch cover, supporting element
15 Operating cylinder
16 Operating piston
17 Pressure zone
18 Connecting line
19 Clutch control valve
20 Return spring
21 Compressed air supply device
22 Compressor, pressure medium pump
23 Pressure limiting valve
24 Pressure reservoir
25 System pressure line
26 Connecting line
27 Depressurized line
30 Check valve
31 Pressure reservoir
32 Pressure limiting valve
33 Pressure sensor
34 2/2-way valve
35 2/2-way valve

1-18. (canceled)

19. A drive train of a motor vehicle comprising:
a drive engine (2) and a transmission (4), having variable transmission ratios, connected to an axle drive (5);
an automatic frictional engine clutch (3) which is located in a flow of power between the drive engine (2) and the transmission (4), and the friction clutch (3) being actively engaged to transmit torque (clutch torque) by a controlled pressure medium; and
the engine clutch (3) having a pressing apparatus (6) that is connected to a pressure medium source (7) such that, in a non-actuated state, the engine clutch (3) is engaged by applying a maximum amount of active pressure to the pressing apparatus (6) and, in an actuated state, the engine clutch (3) is one of partially disengaged, to reduce torque transmission, and substantially completely disengaged by reducing the amount of the active pressure to the pressing apparatus (6).

20. The drive train according to claim 19, wherein the pressing apparatus (6) comprises an operating cylinder (15), an operating piston (16) mounted axially displaceably in the operating cylinder (15) and a pressure zone (17), which is defined by the operating cylinder (15) and the operating piston (16), the pressure zone (17) is connected to the pressure medium source (7) via a connecting line (18) and a clutch control valve (19), one of the operating cylinder (15) and the operating piston (16) is connected to a supporting element (14) of the engine clutch (3) and the other one of the operating cylinder (15) and the operating piston (16) is connected to a pressing element (13) of the engine clutch (3).

21. The drive train according to claim 20, wherein the engine clutch (3) is one of a single-disk clutch and a multi-disk dry clutch, with a clutch cover (14) attached to a flywheel (12) of the drive engine (2) and the pressing element is a pressure plate (13) located on a transmission side of the pressing apparatus (6), the operating cylinder (15) comprises an annular molding of the clutch cover (14) and a correspondingly ring-shaped operating piston (16) is connected to the pressure plate (13).

22. The drive train according to claim 19, wherein the pressure medium source (7) is a pressure supply device (21) with a pressure reservoir (24) displaced by a pressure medium pump (22).

23. The drive train according to claim 22, wherein the pressing apparatus (6) is actuated pneumatically and is connected to a compressed air supply device (21) of the motor vehicle.

24. The drive train according to claim 22, wherein the pressing apparatus (6) is actuated hydraulically and is connected to a hydraulic pressure supply device (21) of the motor vehicle.

25. The drive train according to claim 20, wherein, when the engine clutch (3) is in the non-actuated state, communication from the pressure medium source (7) through a clutch control valve (19) to a connecting line (18) is completely open and communication from the connecting line (18) through the clutch control valve (19) to a depressurized line (27) is completely closed, and when the engine clutch (3) is in the actuated state, communication from the pressure medium source (7) through a clutch control valve (19) to a first connecting line (18) is at least partially closed and communication from the first connecting line (18) through the clutch control valve (19) to the depressurized line (27) is at least partially open.

26. The drive train according to claim 25, wherein the clutch control valve (19) is a pressure control valve and is connected, via a second connecting line (26), to the pressure medium source (7), via the first connecting line (18), to the pressure zone (17) of the pressing apparatus (6) and is connected to the depressurized line (27).

27. The drive train according to claim 26, wherein the clutch control valve (19) is one of a 3/2-way valve and two 2/2-way valves (34, 35), a first of the two 2/2-way valves (34) is connected to the pressure medium source (7), via the second connecting line (26), and to the pressure zone (17) via the second connecting line (18), and a second of the two 2/2-way valves (35) is connected to the pressure zone (17), via the first connecting line (18), and to the depressurized line (27), via a further connection.

28. The drive train according to claim 26, wherein pressure in the pressure zone (17) is detected by a pressure sensor (33) and controls at least one of the clutch control valve (19), the first and the second 2/2-way valves (34, 35), and the clutch torque transmission.

29. The drive train according to claim 20, wherein a check valve (30), closing in a direction of the pressure medium source (7), is located between the clutch control valve (19) and the pressure medium source (7) to maintain control of the engine clutch (3) when a loss of pressure from the pressure medium source (7) occurs.

30. The drive train according to claim 20, wherein a separate pressure reservoir (31) is located, between the clutch control valve (19) and the pressure medium source (7), to maintain control of the engine clutch (3) when a loss of pressure from the pressure medium source (7) occurs.

31. The drive train according to claim 20, wherein a controllable pressure limiting valve (32) is located between the clutch control valve (19; 34, 35) and the pressure medium source (7) to limit the pressure between the pressure medium source (7) and the engine clutch (3).

32. The drive train according to claim 19, wherein at least one of the engine clutch (3) and the pressing apparatus (6) has a return spring (20) to completely disengage the engine clutch (3) if the pressing apparatus (6) is depressurized.

33. A method for controlling an automatic engine clutch disposed in the drive train (1) of a motor vehicle in the power flow between a drive engine (2) and a transmission (5), having variable transmission ratios, connected to an axle drive (5), the engine clutch (3) is an actively engagable friction clutch that controllably transmits torque (clutch torque) by controlling a pressure medium, the method comprising the steps of:
providing the engine clutch (3) with a pressing apparatus (6) and no pressing spring;
connecting the pressing apparatus (6) to a pressure medium source (7);
controlling the pressing apparatus (6) with the pressure medium to one of engage and disengage the engine clutch (3);
when the engine clutch (3) is in a non-actuated state, engaging the engine clutch (3) by applying a maximum pressure to the pressing apparatus (6); and
when the engine clutch (3) is in an actuated state, one of at least partially disengaging and completely disengaging the engine clutch (3), by reducing the pressure to the pressing apparatus (6), to reduce the torque transmission.

34. The method according to claim 33, further comprising the steps of:
completely opening (28) communication through a clutch control valve (19) to allow flow of the pressure medium from the pressure medium source (7) to the connecting line (18) and completely closing communication through the clutch control valve (19) to prevent flow of the pressure medium from the connecting line (18) to a depressurized line (27), when the engine clutch (3) is in the non-actuated state; and
at least partially closing communication through a clutch control valve (19) to at least partially prevent flow of the pressure medium from the pressure medium source (7) to the connecting line (18) and at least partially opening communication through the control valve (19) to at least partially allow flow of the pressure medium from the connecting line (18) to the depressurized line (27), when the engine clutch is in the actuated state.

35. The method according to claim 33, further comprising the step of controlling the torque transmission of the engine clutch (3) with a pressure control function via the pressing apparatus (6).

36. The method according to claim 33, further comprising the step of detecting and employing a pressure in a pressure zone (17) to control at least one of a clutch control valve (19; 34, 35) and the torque transmission of the engine clutch (3, 8).
